(19) United States
(12) Patent Application Publication
(10) Pub. No.: US 2005/0021566 A1
(43) Pub. Date: Jan. 27, 2005

(54) Techniques for facilitating backup and restore of migrated files

(75) Inventor: Yuedong Mu, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Arkivio, Inc., Mountain View, CA (US)

(21) Appl. No.: 10/857,174

(22) Filed: May 28, 2004

Related U.S. Application Data
(60) Provisional application No. 60/474,879, filed on May 30, 2003.

(51) Int. Cl. G06F 7/00

(52) U.S. Cl. 707/200

(57) ABSTRACT

Techniques for facilitating backup and restore operations in a storage environment comprising migrated files. Backup and restore operations on migrated files are performed without triggering recall while maintaining data integrity.

### CROSS-REFERENCES TO RELATED APPLICATIONS

The present application claims the benefit of U.S. Provisional Patent Application No. 60/474,879 filed May 30, 2003 (Attorney Docket No. 21154-001200US), the entire contents of which are herein incorporated by reference for all purposes.

### BACKGROUND OF THE INVENTION

The present invention relates to data storage and management, and more particularly to techniques that facilitate backup and restore operations to be performed on migrated files without triggering recalls.

Data storage demands have grown dramatically in recent times as an increasing amount of data is stored in electronic form. These increasing storage demands have given rise to heterogeneous and complex storage environments comprising storage systems and devices with different cost, capacity, bandwidth, and other performance characteristics. Due to their heterogeneous nature, managing storage of data in such environments is a complex and costly task.

Several solutions have been designed to reduce costs associated with data storage management and to make efficient-use of available storage resources. For example, Hierarchical Storage Management (HSM) storage applications, Information Lifecycle Management (ILM) applications, etc. are able to automatically and transparently migrate data along a hierarchy of storage resources to meet user needs while reducing overall storage management costs. The storage resources may be hierarchically organized based upon costs, speed, capacity, and other factors associated with the storage resources. For example, files may be migrated from online storage to near-line storage, from near-line storage to offline storage, and the like.

In storage environments where data is migrated, when a file located in an original storage location on an original storage unit is migrated, a portion (e.g., the data portion) of the file (or the entire file) is moved from the original storage location to another storage location (referred to as the “repository storage location” or “migration target repository”) that may be on some remote server. A stub file (or tag file) is usually left in place of the migrated file in the original storage location. The stub file serves as an entity in the original storage location that is visible to the user and/or applications and through which the user and/or applications can access the original file. Users and applications can access the migrated file as though the file was still stored in the original storage location. When a storage management application (e.g., HSM, ILM) receives a request to access the migrated file, the application determines the repository storage location of the migrated data corresponding to the stub file and recalls (or demigrates) the migrated file data from the repository storage location back to the original storage location.

The information stored in a stub file may vary in different storage environments. For example, in one embodiment, a stub file may store information that may be used by the storage management application to locate the migrated data. In certain embodiments, the information that is used to locate the migrated data may also be stored in a database rather than in the stub file, or in addition to the stub file. The migrated data may be remigrated from the repository storage location to another repository storage location. The stub file information and/or the database information may be updated to reflect the changed location of the migrated or remigrated data.

In other embodiments, a stub file may store metadata associated with the migrated file. The metadata may include information related to various attributes associated with the migrated file such as security attributes, file attributes, extended attributes, etc. In certain embodiments, the stub file may also store or cache a portion of the data portion of the file.

Backup and restore are important functions that are performed in any storage environment. Whenever a backup operation is performed on a migrated file in conventional storage environments where data is migrated, the backup operation causes the migrated data for the file to be recalled from the repository storage location to the original storage location on the original storage unit before the backup is performed. Recall operations incur several detrimental overheads. Recall operations result in increased network traffic that may adversely affect the performance of the storage environment. A recall operation consumes valuable storage space on the original storage unit. This may be problematic if the storage units are experiencing a storage capacity problem. Further, a recall operation requires that the original storage unit have enough storage space for storing the recalled data. If the requisite space is not available on the original storage unit, then the recall operation will fail and as a result the backup operation that triggered the recall will also fail.

In other conventional implementations, the backup application has to understand the internals of a stub file in order to properly backup the stub file. However, stub file implementations are generally proprietary and not known to the backup software. As a result, backup and restore applications may not be able to properly perform backup and restore operations.

In light of the above, techniques are desired that can facilitate backup and restore operations on migrated files without triggering recalls or without knowing the internals of stub files.

### BRIEF SUMMARY OF THE INVENTION

Embodiments of the present invention provide techniques for facilitating backup and restore operations in a storage environment comprising migrated files. Backup and restore operations on migrated files are performed without triggering recall while maintaining data integrity.

According to an embodiment of the present invention, techniques are provided for performing a backup operation. It is detected that a backup application is backing-up a stub file to a backup medium, wherein the stub file is stored in a first storage location in place of a first file due to migration of a portion of or the entire first file from the first storage location. The backup of the stub file to the backup medium is enabled without recalling the migrated portion to the first storage location.

According to another embodiment of the present invention, techniques are provided for restoring a file. It is detected that a restore application has restored a first file from a backup medium to a first storage location. It is determined that the first file is a stub file corresponding to a first file, wherein a portion of or the entire first file has been migrated from the first storage location. A logical size of the restored stub file is set to a logical size of the first file prior to migration of the portion of the first file.

According to another embodiment of the present invention, an apparatus is provided for performing a file backup operation. The apparatus comprises a first storage unit, a second storage unit, a backup medium, and a data processing system. The first storage unit stores a stub file in place of a first file due to migration of a portion of the first file from the first storage unit to the second storage unit. The data processing system is configured to detect that a backup application is backing-up the stub file to the backup medium. The data processing system enables backup of the stub file to the backup medium without recalling the migrated portion from the second storage unit to the first storage unit.

According to another embodiment of the present invention, an apparatus is provided for performing restoring a file. The apparatus comprises a first storage unit, a second storage unit, a backup medium, and a data processing system. The data processing system is configured to detect that a restore application has restored a file from the backup medium to the first storage unit. The data processing system determines that the restored file is a stub file corresponding to a first file, wherein a portion of the first file has been migrated from the first storage unit to the second storage unit. The data processing system sets a logical size of the restored stub file to a logical size of the first file prior to migration of the portion of the first file.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a storage environment that may incorporate an embodiment of the present invention;

FIG. 2 is a simplified block diagram depicting modules that may be used to implement an embodiment of the present invention;

FIG. 3 is a simplified high-level flowchart depicting a method of performing a backup operation on a migrated file without triggering a recall according to an embodiment of the present invention;

FIG. 4 is a simplified high-level flowchart depicting a method of performing a restore operation on a backed-up migrated file without triggering a recall according to an embodiment of the present invention; and

FIG. 5 is a simplified block diagram of a computer system that may be used to perform processing according to an embodiment of the present invention.

### DETAILED DESCRIPTION OF THE INVENTION

In the following description, for the purposes of explanation, specific details are set forth in order to provide a thorough understanding of the invention. However, it will be apparent that the invention may be practiced without these specific details.

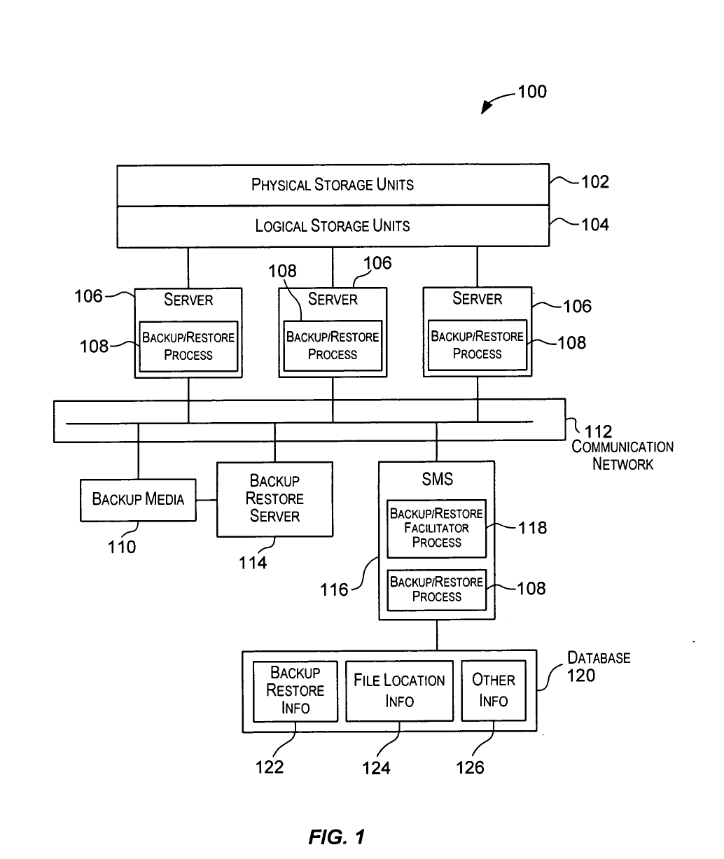

FIG. 1 is a simplified block diagram of a storage environment 100 that may incorporate an embodiment of the present invention. Storage environment 100 depicted in FIG. 1 is merely illustrative of an embodiment incorporating the present invention and does not limit the scope of the invention as recited in the claims. One of ordinary skill in the art would recognize other variations, modifications, and alternatives.

As depicted in FIG. 1, storage environment 100 comprises physical storage devices or units 102 for storing data. Physical storage units 102 may include disk drives, tapes, hard drives, optical disks, RAID storage structures, solid state storage devices, SAN storage devices, NAS storage devices, and other types of devices and storage media capable of storing data. The term “physical storage unit” is intended to refer to any physical device, system, etc. that is capable of storing information or data.

Physical storage units 102 may be organized into one or more logical storage units 104 that provide a logical view of underlying disks provided by physical storage units 102. Each logical storage unit (e.g., a volume) is generally identifiable by a unique identifier (e.g., a number, name, etc.) that may be specified by the user. A single physical storage unit may be divided into several separately identifiable logical storage units. A single logical storage unit may span storage space provided by multiple physical storage units 102. A logical storage unit may reside on non-contiguous physical partitions. By using logical storage units, the physical storage units and the distribution of data across the physical storage units becomes transparent to servers and applications.

For purposes of describing the present invention, logical storage units 104 are considered to be in the form of volumes. However, other types of logical storage units are also within the scope of the present invention. The term “storage unit” is intended to refer to a physical storage unit (e.g., a disk) or a logical storage unit (e.g., a volume).

Several servers 106 are provided that serve as access points to storage units 102 or 104. For example, one or more volumes from logical storage units 104 may be assigned or allocated to each server from servers 106. A server 106 provides an access point for the one or more volumes allocated to that server.

Backup and restore operations for storage environment 100 may be performed by backup/restore processes or applications 108. Backup/restore processes 108 may be executed by servers 106. Backup/restore processes 108 may be configured to backup data to backup media 110 and to restore data from backup media 110. Although, backup media 110 is shown separate from storage units 102 and 104 in FIG. 1, in alternative embodiments, backup media 110 may be a part of storage units 102 and 104. The backup and restore operations may be performed by a single process or application or may alternatively be performed by multiple separate processes and applications.

Backup operations may be performed at periodic user specified intervals (e.g., at midnight every day, every hour, etc.), may be performed when requested by a user such as a network administrator, or may be performed as requested by storage policies configured for the storage environment. Backup may be performed on a per file basis, for a plurality of files, for one or more logical storage units (e.g., for one or more user-specified volumes), for one or more physical storage units, etc. Backups may also be performed on a block basis. In some embodiments, a backup-restore server 114 may be provided for performing the backup and restore operations.

As depicted in FIG. 1, a storage management server/system (SMS) 116 may be coupled to the storage resources and the servers via communication network 112. Communication network 112 provides a mechanism for allowing communication between SMS 116, servers 106, and backup-restore sever 114. Communication network 112 may be a local area network (LAN), a wide area network (WAN), a wireless network, an Intranet, the Internet, a private network, a public network, a switched network, or any other suitable communication network. Communication network 112 may comprise many interconnected computer systems and communication links. The communication links may be hardwire links, optical links, satellite or other wireless communications links, wave propagation links, or any other mechanisms for communication of information. Various communication protocols may be used to facilitate communication of information via the communication links, including TCP/IP, HTTP protocols, extensible markup language (XML), wireless application protocol (WAP), Fiber Channel protocols, protocols under development by industry standard organizations, vendor-specific protocols, customized protocols, and others.

SMS 116 may be configured to provide services for managing storage environment 100. For example, storage management applications (e.g., HSM applications, ILM applications, etc.) that control migration and recall of data may be executed by SMS 116. The storage applications may also be executed by servers 106.

Migration is a process or operation where a portion (or even the entire file) of the file being migrated is moved from an original storage location on an original volume where the file is stored prior to migration to a repository storage location on a repository volume. The migrated portion of the file may include, for example, the data portion of the file. In certain embodiments, the migrated portion of the file may also include a portion of (or the entire) metadata associated with the file. The metadata may comprise information related to attributes such as security attributes (e.g., ownership information, permissions information, access control lists, etc.), file attributes (e.g., file size, file creation information, file modification information, access time information, etc.), extended attributes (attributes specific to certain file systems, e.g., subject information, title information), sparse attributes, alternate streams, etc. associated with the file.

As result of migration, a stub or tag file may be left in place of the original file in the original storage location on the original volume. The stub file is a physical file that serves as an entity in the original storage location that is visible to the user and/or applications and through which the user and/or applications can access the original file. Users and applications can access the migrated file as though the file was still stored in the original storage location using the stub file. When a storage management application (e.g., HSM, ILM) receives a request to access the migrated file, the application determines the repository storage location of the migrated data corresponding to the stub file and recalls (or demigrates) the migrated file data from the repository storage location back to the original storage location. The location of the migrated data may be determined from a database storing information for migrated files. For example, the information may be stored in a database such as database 112 depicted in FIG. 1 as part of file location information 114. In some embodiments, the location may also be determined from information stored in the stub file.

The information stored in a stub file may vary in different storage environments. For example, in one embodiment, a stub file may store information that may be used by the storage management application to locate the migrated data. In some embodiments, a stub file may store metadata associated with the migrated file. The metadata may include information related to various attributes associated with the migrated file such as security attributes, file attributes, extended attributes, etc. In certain embodiments, the stub file may also store or cache a portion of the data portion of the file.

In some embodiments, as a result of migration, information related to the migrated file such as information identifying the original volume, the repository volume, information identifying the repository storage location, etc. may also be stored in a centralized location. For example, the information may be stored in a database such as database 120 depicted in FIG. 1 that stores file location information 124 that comprises information related to migrated files. In some embodiments, the metadata information may also be stored in database 120. The stored metadata information may be used to recreate metadata information for a restored file, as described below.

A recall operation is an operation in which migrated data for a migrated file is recalled or moved from the repository storage location (on the repository storage unit) back to the original storage location on the original storage unit. A recall operation is generally triggered upon receiving a request to access a migrated file. Data may be migrated and recalled to and from storage units 102 or 104 depicted in FIG. 1.

As shown in FIG. 1, a backup/restore process 108 may also be executed by SMS 116. According to an embodiment of the present invention, SMS 116 is configured to execute a backup-restore facilitator process (BRFP) or application 118 that is configured to facilitate backup and restore operations for migrated files without triggering a recall. In alternative embodiments, the functionality provided by BRFP 118 may also be provided by processes or applications executed by servers 106 and/or backup-restore server 114.

According to an embodiment of the present invention, BRFP 118 is configured to automatically detect and intercept file operations performed by any backup and restore process. This may be performed using various techniques. In one embodiment, the system administrator may specify the names of one or more processes that perform backup and/or restore operations. Whenever BRFP 118 detects such a specified process, it intercepts the file operations performed by the process. The system administrator may also specify names of user that are allowed to perform backup and/or restore operations. BRFP 118 may detect that a backup or restore process is being run based upon the user name running the process. Information identifying the processes to be detected and intercepted and user names may be stored in database 120 in the form of backup-restore information 122. In some embodiments, backup-restore information 122 may also store metadata information for a backed-up file prior to backup. This stored metadata information may be used to recreate metadata information for a backed-up file when it is restored.

During a backup operation, BRFP 118 is configured to determine the virtual size of the migrated file being backed up and only feed the necessary data from the migrated file to the backup process while maintaining data integrity in real time. In this manner, BRFP 118 facilitates backup of migrated files (i.e., backup of stub files that are present in the original storage location representing the migrated files) without triggering a recall operation. BRFP 118 is also configured to reconstruct the stub file corresponding to a migrated file during a restore operation in real time. BRFP 118 is also configured to perform recovery operations when errors occur during the backup or restore operations. Further details on functions performed by BRFP 118 that facilitate backup and restore operations without triggering recall are provided below.

As depicted in FIG. 1, database 120 provides a repository for storing information that is used to perform storage management operations, including storing information that is used to facilitate backup and restore operations without triggering recall according to the teachings of the present invention. In addition to backup-restore information 122 and file location information 124, database may also store other information 126 that may comprise information related to storage policies and rules configured for the storage environment, information related to the various monitored storage units, information related to the files stored in the storage environment, and the like. Database 112 may be embodied in various forms including a relational database, directory services, data structure, etc. The information may be stored in various formats.

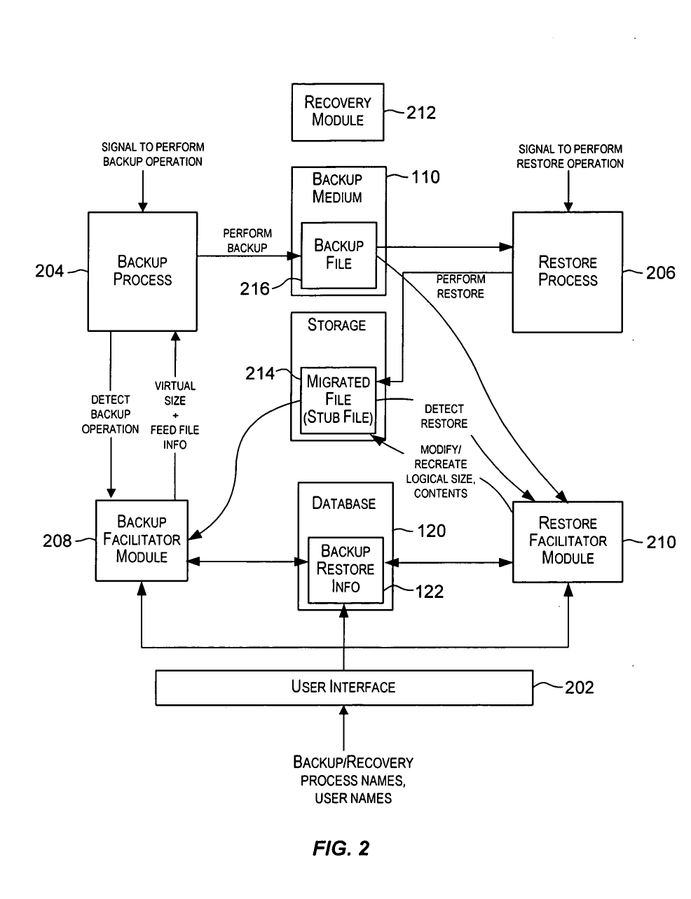

FIG. 2 is a simplified block diagram depicting modules that may be used to implement an embodiment of the present invention. The modules depicted in FIG. 2 may be implemented in software, hardware, or combinations thereof. It should be understood that the modules depicted in FIG. 2 are merely illustrative of an embodiment of the present invention and are not meant to limit the scope of the invention. One of ordinary skill in the art would recognize other variations, modifications, and alternatives.

The modules depicted in FIG. 2 include a user interface module 202, a backup process module 204, a restore process module 206, a backup facilitator module 208, a restore facilitator module 210, and a recovery module 212. User interface module 202 allows users (e.g., an administrator) to provide information that may be used by backup facilitator module 208 and restore facilitator module 210 to facilitate backup and restore operations of migrated files without triggering data recall. For example, a user may specify information identifying names of backup and restore processes and user names that are allowed to perform backup and restore operations via user interface module 202. Backup facilitator module 208 and restore facilitator module 210 use this information to determine when a backup or restore operation is being performed. The information provided by the user may be stored as backup-restore information 122 in database 120.

User interface 202 may also provide an interface for outputting status information related to the file operations. The status information may comprise information indicating the progress of the backup and restore operations, error conditions information, etc.

User interface 202 may be implemented in various forms such as a browser-based user interface, a graphical user interface, text-based command line interface, or any other application that allows a user to specify information for managing a storage environment and that enables a user to receive feedback, statistics, reports, status, and other information related to the storage environment.

Backup process 204 represents any conventional process or application that is configured to perform backup operations in a storage environment. The backed-up data may be stored in backup medium 110. The backups may be performed at regular time intervals (e.g., at midnight every day, every hour, etc.), when requested by a user or some other process or application, or when requested by storage policies configured for the storage environment. Accordingly, backup process 204 may receive a signal to perform a backup operation from various sources.

Backups may be performed on a per file basis, for a plurality of files, for one or more logical storage units (e.g., for one or more user-specified volumes), for one or more physical storage units, etc. Backups may also be performed on a block basis.

Restore process 206 represents any conventional process or application that is configured to perform restore operations in a storage environment. Restore process 206 is configured to restore data from backup medium 110. Restore operations may be also performed at regular time intervals (e.g., at midnight every day, every hour, etc.), when requested by a user or some other process or application, or when requested by storage policies configured for the storage environment. Accordingly, restore process 206 may receive a signal to perform a restore operation from various sources. Restores may be performed on a per file basis, for a plurality of files, for one or more logical storage units (e.g., for one or more user-specified volumes), for one or more physical storage units, etc. Restore operations may also be performed on a block basis.

Although backup process 204 and restore process 206 are shown as separate processes in FIG. 2, it should be apparent to one skilled in the art that in alternative embodiments, the backup and restore operations may be performed by a single application or process or alternatively by several different applications or processes working in conjunction.

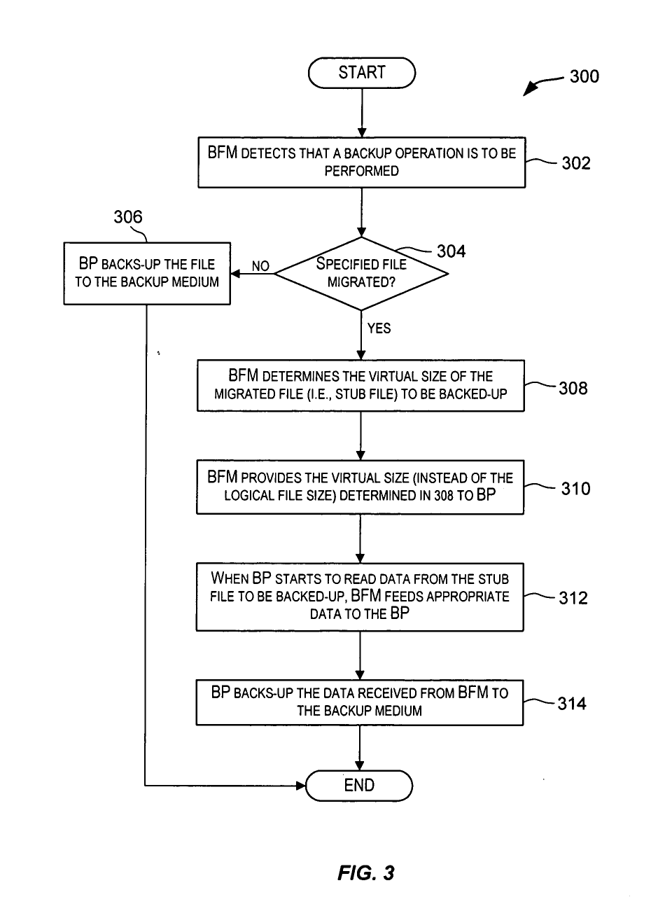

Backup facilitator module 208 is configured to facilitate performance of backup operations for migrated files such that no recall is performed as a result of the backup operations. Backup facilitator module 208 may use the backup-restore information 122 stored in database 120 to determine when a backup process is initiated. Further details related to the functions performed by backup facilitator module 208 are described below with reference with FIG. 3.

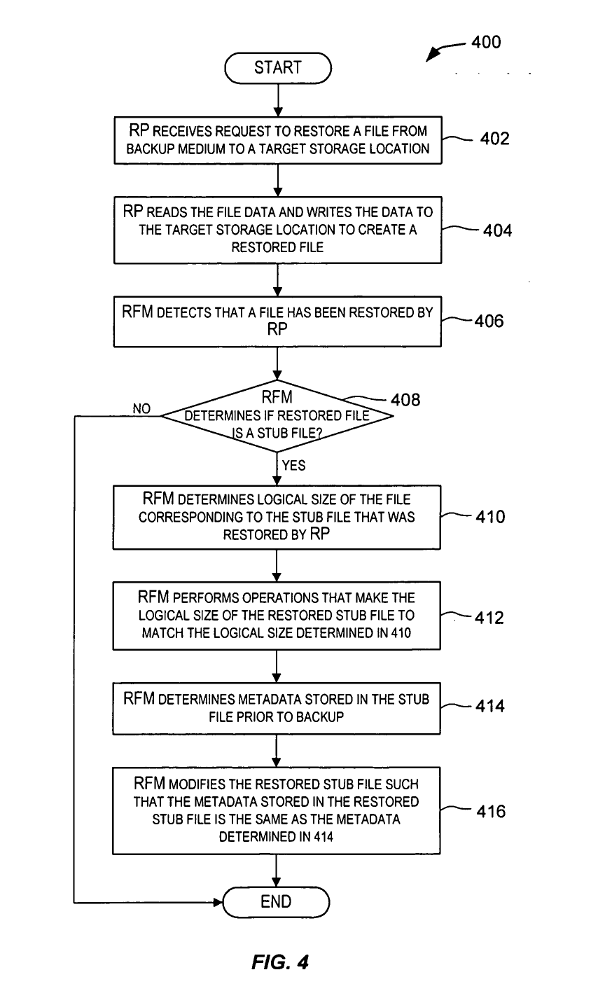

Restore facilitator module 210 is configured to facilitate performance of restore operations for migrated files such that no recall is performed as a result of the restore operations. Restore facilitator module 210 may use backup-restore information 122 stored in database 120 to determine when a restore process is initiated. Further details related to the functions performed by restore facilitator module 210 are described below with reference with FIG. 4.

Although backup facilitator module 208 and restore facilitator module 210 are shown as separate modules in FIG. 2, it should be apparent to one skilled in the art that in alternative embodiments, the functionality of the modules may be provided by a single application, process, or module, or alternatively by several different applications, processes, or modules working in conjunction.

Recovery module 212 is configured to perform recovery operations that may be needed to maintain integrity of the file system when an error occurs during a backup or restore operation.

FIG. 3 is a simplified high-level flowchart 300 depicting a method of performing a backup operation on a migrated file without triggering a recall according to an embodiment of the present invention. The method depicted in FIG. 3 may be performed by software modules executed by a processor, hardware modules, or combinations thereof. Flowchart 300 depicted in FIG. 3 is merely illustrative of an embodiment of the present invention and is not intended to limit the scope of the present invention. Other variations, modifications, and alternatives are also within the scope of the present invention. The method depicted in FIG. 3 may be adapted to work with different implementation constraints.

As depicted in FIG. 3, processing is initiated when backup facilitator module 208 (BFM in FIG. 3) detects that a backup operation is to be performed (step 302). As previously described, there are various ways in which backup facilitator module 208 may determine that a backup operation is about to be performed. In one embodiment, backup facilitator module 208 is provided or accesses information identifying processes (e.g., process names, process identifiers, etc.) and users that are configured to perform backup operations. Backup. facilitator module 208 is configured to monitor file operations (e.g., a file “open” operation) that indicate some sort of file access. When such a file operation is detected, backup facilitator module 208 then determines if the file operation is being performed by a process or user that is specified as a backup process or user. If so, then backup facilitator module 208 determines that a backup operation is about to be performed. Upon detecting a backup operation, backup facilitator module 208 intercepts the file operations performed by the backup operation.

Backup facilitator module 208 then determines if the file that is the target of the backup operation is a migrated file (step 304). The determination may be made using several techniques. According to one technique, if a stub file is located in place of the actual file to be backed-up in the original storage location, then this indicates that the file has been migrated. According to another technique, information stored for migrated files (e.g., file location information 124 stored in database 120) may be queried to determine if the specified file to be backed-up has been migrated.

If it is determined in 304 that the file that is the target of the backup operation has not been migrated, then backup process or application 204 (BP in FIG. 3) is allowed to backup the file (step 306) and this completes the file backup operation. Since the file has not been migrated, the backup operation does not trigger a recall.

If it is determined in 304 that the file that is the target of the backup operation has been migrated, then processing continues with step 308. If the file that is the target of the backup operation has been migrated, a stub file is located in the original storage location in place of the migrated file. Accordingly, the stub file corresponding to the migrated file will be backed-up as a result of the backup operation.

Backup applications (such as backup process 204) look at a file's logical size to perform backups. The logical size of a file is the size of the file before migration. Even for a migrated file, the logical size of the migrated file is used for backup. The allocation size of the file is the actual memory space taken by the file in storage. Accordingly, even though a stub file may store only metadata having a size less than the logical size, the backup file that is created has a size equal to the logical size (null data may be added to the backup). As a result, memory on the backup medium is unnecessarily wasted to store the null data. To solve this problem, upon determining that the file to be backed up is a migrated file and a stub file is in place of the migrated file, backup facilitator module 208 determines the virtual size of the migrated file (or stub file) that will be the target of the backup operation (step 308).

The virtual size of the migrated file may be the same as or different from the logical size of the migrated file. The virtual size is determined based upon the contents of the stub file corresponding to the migrated file. According to an embodiment of the present invention, the virtual size is determined to be the size of the contents of the stub file.

As previously described, a stub file may store different contents in different storage environments. For example, in one scenario, the stub file may store metadata associated with the migrated file. As previously described, the metadata may comprise data related to attributes of the file such as security attributes (e.g., ownership information, permissions information, access control lists, etc.), file attributes (e.g., file size, file creation information, file modification information, access time information, etc.), extended attributes (attributes specific to certain file systems, e.g., subject information, title information), sparse attributes, alternate streams, etc. In some embodiments, the logical size of the file may be stored as part of the metadata or attributes information. The logical size information may also be stored in a database such as database 120 depicted in FIG. 1. In another scenario, the stub file may store metadata or attributes data associated with the migrated file and a cached portion of the file data that has been migrated to some remote location. In yet another scenario, the stub file may store metadata, cached data, and other data. The other data may store some other information related to the file. The other data may also possibly be null data.

In 308, backup facilitator module 208 computes the virtual size of the migrated file based upon the contents of the stub file. The virtual size may be the size of the contents of the stub file. Accordingly, if the stub file comprises only metadata, then the virtual size is computed to be equal to the size of the metadata. If the stub file comprises metadata and cached data, then the virtual size is computed as the sum of the size of the metadata and the size of the cached data. If the stub file comprises metadata, cached data, and other information, then the virtual size is computed as the sum of the size of the metadata, the size of the cached data, and size of the other information. The virtual size does not exceed the logical size.

For example, let us assume that the original size of a file is 1000 K. After migration, if the stub file corresponding to the file stores only metadata of size 1 K, then the virtual size is determined to be 1 K. If in addition to the 1 K metadata, the stub file also stores cached data of size 64 K, then the virtual size is determined to be 65 K (i.e., 1 K+64 K). If the stub file stores metadata of size 1 K, cached data of size 64 K, and other data of size 100 K, then the virtual size is determined to be 165 K (i.e., 1 K+64 K+100 K).

Backup facilitator module 208 then provides the virtual size (instead of the logical size) determined in step 308 to backup process 204 (step 310). Backup process 204 uses the virtual size provided by backup facilitator module 208 as the amount of data to be backed-up.

When backup process 204 starts to read the data from the stub file to be backed-up, backup facilitator module 208 intercepts the read operation and feeds appropriate data to backup process 204 (step 312). As part of 312, backup facilitator module 208 provides data from the stub file to backup process 204. For example, if stub file comprises metadata and the virtual size provided to backup process 204 in 310 is the size of the metadata, then backup facilitator module 208 reads the metadata from the stub file and feeds it to backup process 204 in 312. If the stub file stores metadata and cached data and the virtual size provided to backup process 204 in 310 is the size of the metadata plus the size of the cached data, then backup facilitator module 208 reads the metadata followed by the cached data from the stub file and provides it to backup process 204 for backup. If the stub file stores metadata, cached data, and some other data, and the virtual size provided to backup process 204 is the sum of the metadata, the cached data, and the other data, then backup facilitator module 208 provides the metadata, cached data, and other data to backup process 204.

Backup process 204 backs up the data received from backup facilitator module 208 to backup medium 110 and creates a backup file on the backup medium (step 314). For example, as depicted in FIG. 2, a backup file 216 is created for stub file 214. Information may be stored in database 120 (e.g., as part of backup-restore information 122) to indicate that the backed-up file is a stub file or migrated file.

In the manner described above, the stub file and its contents are properly backed-up. The backup operation is performed without triggering a recall of the migrated data corresponding to the stub file. The virtual size provided to backup process 204 is generally considerably less (usually the size of the contents of the stub file) than the logical size of the file. Accordingly, the storage space of the backup medium is efficiently used as only the amount of space required to store the contents of the stub file is used.

Further, from the perspective of backup process 204, there is no difference between backing-up a normal file or a migrated file. Backup facilitator module 208 takes care of the special processing that is performed for migrated files. The backup operation is successfully performed without backup process 204 having to know the internal implementation details of the stub file. The backup operation is performed while maintaining transparency of migrated files.

The processing performed in FIG. 3 is also depicted in FIG. 2. Backup facilitator module 208 detects a backup operation for a migrated file 214, provides virtual size information to backup process 204 based upon contents of stub file 214, and provides appropriate data from the stub file to backup process 204. Backup process 204 backs up the data received from backup facilitator module 208 to create a backup file 216 on backup medium 110.

Various measures may be used to preserve the consistency of the file system due to errors that may occur during the backup operation described above. The recovery operations may be performed by recovery module 212 depicted in FIG. 2.

FIG. 4 is a simplified high-level flowchart 400 depicting a method of performing a restore operation on a backed-up migrated file without triggering a recall according to an embodiment of the present invention. The method depicted in FIG. 4 may be performed by software modules executed by a processor, hardware modules, or combinations thereof. Flowchart 400 depicted in FIG. 4 is merely illustrative of an embodiment of the present invention and is not intended to limit the scope of the present invention. Other variations, modifications, and alternatives are also within the scope of the present invention. The method depicted in FIG. 4 may be adapted to work with different implementation constraints.

As depicted in FIG. 4, processing is initiated when restore process (RP in FIG. 4) or application 206 receives a request to restore a file from a backup medium to a target storage location (step 402). The request may be received responsive to a user action (e.g., the user requests the file to be restored) or may be received from an application or process.

Restore process 206 then reads the contents of the file to be restored from backup medium and writes the contents to the target storage location to create a restored file (step 404). Restore facilitator module 210 (RFM in FIG. 4) detects that a file has been restored by restore process 206 (step 406). There are various ways in which restore facilitator module 210 detects that a file has been restored. In one embodiment, restore facilitator module 210 is provided or accesses information identifying processes (e.g., process names, process identifiers, etc.) and users that are configured to perform restore operations. Restore facilitator module 210 is configured to monitor file operations (e.g., file open and file close operations) that indicate creation of a file. When such file operations are detected, restore facilitator module 210 then determines if the file operations are performed by a process or user that is specified as a restore process or user. If so, then restore facilitator module 210 determines that a restore operation has been performed. According to an embodiment of the present invention, restore facilitator module 210 intercepts file close operations of a restore operation performed by restore process 206 and then performs the processing depicted in steps 408, 410, 412, 414, and 416.

According to an embodiment of the present invention, as part of 406, restore facilitator module 210 is able to distinguish between a restore operation and other file operations such as a “remove” or “recreate” operations based upon the process name/identifier or user name/identifier that performed the file operation. In “remove” or “recreate” operations for a stub file, the corresponding migrated data in the repository storage location is to be deleted which is not the case for a restore operation.

Restore facilitator module 210 then determines if the file restored by restore process 206 is a stub file corresponding to migrated file (step 408). Information stored for migrated files (e.g., file location information 124 stored in database 120) may be queried to determine if the specified file to be restored is a stub file. Alternatively, backup-restore information 122 may also be queried to determine if the file to be restored is a stub file. Some application specific attributes may also be stored in the restored stub file that indicate whether or not this is a stub file.

If it is determined in 408 that the restored file is not a stub file, then restore facilitator module 210 does not need to perform any additional operations. Since the restored file is not a stub file, the restore operation does not trigger a recall.

If it is determined in 408 that the restored file that is a stub file, then restore facilitator module 210 determines the logical size of the file corresponding to the restored stub file (step 410). According to an embodiment of the present invention, restore facilitator module 210 may determine the logical size from the metadata stored in the restored stub file. Restore facilitator module 210 may also determine the logical file size by querying file location information 124 comprising information related to migrated files and/or backup-restore information 122 stored in database 120.

Restore facilitator module 210 then performs operations that make the logical size of the restored file equal to the logical size determined in 410 (step 412). According to an embodiment of the present invention, modify (if needed) the logical size information stored for the restored file to match the logical size determined in 410. For example, the logical size information stored in database 120 may be updated to reflect the logical size determined in 410. In some embodiments, the restored stub file may store the logical size information and that information may be updated to match the logical size determined in 410. Setting the logical size of the restored stub file to the logical size determined in 410 ensures that the migrated data can be properly recalled using the restored stub file.

According to another embodiment of the present invention, the size of the restored stub file expanded until it matches the logical size determined in 410 and then the expanded file may be truncated back to its restored size. This causes the logical size for the restored file to match the logical size determined in 410. In this embodiment, restore facilitator module 210 may determine the size (“virtual size”) of the contents of the stub file prior to backup and then truncate the expanded stub file back to the virtual size such the contents of the original stub file are maintained.

Steps 410 and 412 are performed to ensure that migrated data can be properly recalled using the restored stub file. Restore processes or applications such as restore process 206 are configured to restore whatever image is in the backup media of the file. This image however may not have the correct logical size information of the file. Accordingly, the processing in 410 and 412 is performed to fix the logical size of the restored stub file.

In some embodiments, restore facilitator module 210 determines the metadata stored in the stub file prior to it being backed-up and restored (step 414). The metadata stored in the stub file prior to backup represents the metadata associated with the migrated file to which the stub file corresponds. The metadata information may be determined from file location information 124 and/or backup-restore information 122 stored in database 120. Restore facilitator module 210 then modifies the restored stub file such that the metadata stored by the restored stub file is the same as the metadata determined in 414 (step 414). Steps 414 and 416 are performed to ensure that the restored stub file has the same metadata information as it did before backup. This is done to ensure that proper recalls are performed using the restored stub file.

Steps 414 and 416 are especially useful in environments where the metadata (or a portion thereof) associated with a migrated file that is stored in the stub file corresponding to the migrated may be lost when the stub file is backed-up and/or restored by backup process 204 and restore process 206. In some embodiment, the backup process may not backup all the metadata during the backup operation. Steps 414 and 416 enable the “lost” metadata to be recreated for the restored stub file. In certain embodiments, the other contents of the original stub file (i.e., contents of the stub file before it was backed-up) such as cached data and other data may also be recreated using the technique described in steps 414 and 416.

By performing the processing depicted in 410, 412, 414, and 416, restore facilitator module 210 fixes the logical size and metadata of the restored stub file that may have been lost or corrupted as a result of the backup and restore operations performed by backup process 204 and restore process 206. The stub file is fixed such that data recalls are properly performed using the restored stub file.

As described above, the restore operation is performed without triggering a recall of the migrated data while maintaining data integrity of the restored file. The file is restored such that the restored stub file continues to point to the migrated data in the repository storage location and comprises the metadata and other data (e.g., cached data, other data, etc.) that was present in the stub file before the file was backed-up. The restored stub file is such that future operations on the restored stub file will be transparent and consistent. For example, when the restored stub file is accessed, a recall of the migrated data is automatically triggered. In this manner, transparency of migrated files is maintained.

Further, from the perspective of restore process 206, there is no difference between restoring a normal file or a migrated file. The special processing for a migrated file is taken care of by restore facilitator module 210. The restore operation is successfully performed without restore process 206 having to know the internal implementation details of the stub file. The restore operation is performed while maintaining the transparency of migrated files.

The processing performed in FIG. 3 is also depicted in FIG. 2. Restore process 206 receives a signal to restore a file from backup medium 110, reads data from backup file 216, and restores the file. Restore facilitator module 210 detects a stub file is restored, determines the logical size of the file corresponding to the stub file, modifies the logical size of the restored file to match the determined logical size, determines contents (e.g., metadata) of the stub file prior to backup, and recreates the contents in the restored stub file.

Various measures may be used to preserve the consistency of the file system due to errors that may occur during the restore operation described above. The recovery operations may be performed by recovery module 212 depicted in FIG. 2.

Backup and restore operations according to the teachings of the present invention may be performed on a file level or on a block level without triggering recall Further, the operations may be performed on a single file, multiple files, a logical storage unit (e.g., on an entire volume), or on a physical storage unit (e.g., a specified disk).

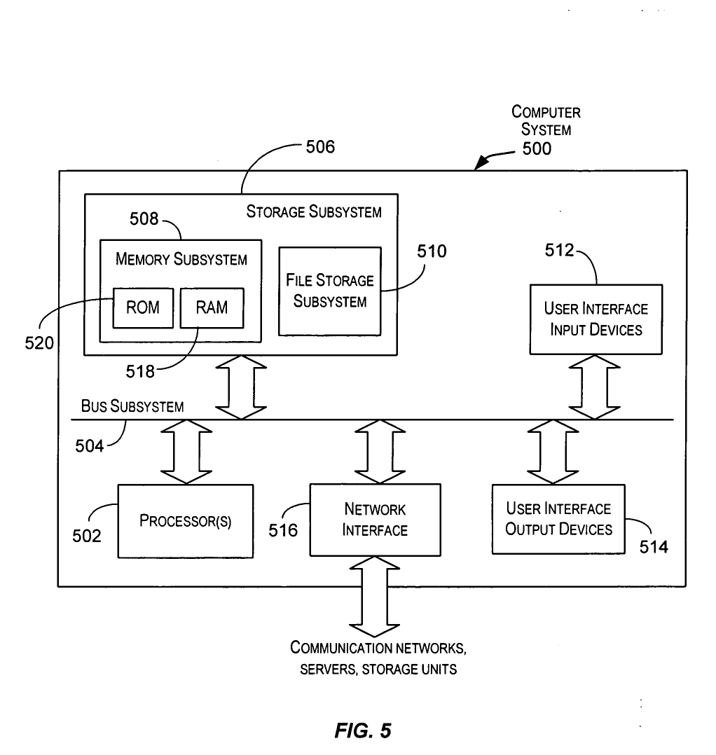

FIG. 5 is a simplified block diagram of a computer system 500 that may be used to perform processing according to an embodiment of the present invention. As shown in FIG. 5, computer system 500 includes a processor 502 that communicates with a number of peripheral devices via a bus subsystem 504. These peripheral devices may include a storage subsystem 506, comprising a memory subsystem 508 and a file storage subsystem 510, user interface input devices 512, user interface output devices 514, and a network interface subsystem 516. The input and output devices allow a user, such as the administrator, to interact with computer system 500.

Network interface subsystem 516 provides an interface to other computer systems, networks, servers, and storage units. Network interface subsystem 516 serves as an interface for receiving data from other sources and for transmitting data to other sources from computer system 500. Embodiments of network interface subsystem 516 include an Ethernet card, a modem (telephone, satellite, cable, ISDN, etc.), (asynchronous) digital subscriber line (DSL) units, and the like.

User interface input devices 512 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to computer system 500.

User interface output devices 514 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 500.

Storage subsystem 506 may be configured to store the basic programming and data constructs that provide the functionality of the present invention. For example, according to an embodiment of the present invention, software code modules (or instructions) implementing the functionality of the present invention may be stored in storage subsystem 506. These software modules or instructions may be executed by processor(s) 502. Storage subsystem 506 may also provide a repository for storing data used in accordance with the present invention. For example, information used for enabling backup and restore operations without performing recalls may be stored in storage subsystem 506. Storage subsystem 506 may also be used as a migration repository to store data that is moved from a storage unit. Storage subsystem 506 may also be used to store data that is moved from another storage unit. Storage subsystem 506 may comprise memory subsystem 508 and file/disk storage subsystem 510.

Memory subsystem 508 may include a number of memories including a main random access memory (RAM) 518 for storage of instructions and data during program execution and a read only memory (ROM) 520 in which fixed instructions are stored. File storage subsystem 510 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Bus subsystem 504 provides a mechanism for letting the various components and subsystems of computer system 500 communicate with each other as intended. Although bus subsystem 504 is shown schematically as a single bus, alternative embodiments of the bus subsystem may utilize multiple busses.

Computer system 500 can be of various types including a personal computer, a portable computer, a workstation, a network computer, a mainframe, a kiosk, or any other data processing system. Due to the ever-changing nature of computers and networks, the description of computer system 500 depicted in FIG. 5 is intended only as a specific example for purposes of illustrating the preferred embodiment of the computer system. Many other configurations having more or fewer components than the system depicted in FIG. 5 are possible.

The techniques described above can be used in any storage environment where portions of a file (e.g., the data portion) or the entire file are moved or migrated from the original location of the file to some other location. Examples of such storage environments include environments managed by HSM applications, by ILM applications, and the like. In such storage environments, embodiments of the present invention can be used to facilitate performance of backup and restore operations on migrated files without triggering a recall. Embodiments of the present invention thus improve the efficiency of backup and restore operations that are performed in such storage environments while preserving consistency of the file system.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

1. A computer-implemented method of performing a file backup operation, the method comprising:
detecting that a backup application is backing-up a stub file to a backup medium, wherein the stub file is stored in a first storage location in place of a first file due to migration of a portion of the first file from the first storage location; and
enabling backup of the stub file to the backup medium without recalling the migrated portion to the first storage location.

2. The method of claim 1 wherein enabling backup of the stub file comprises:
determining a virtual size based upon contents of the stub file;
providing the virtual size to the backup application; and
providing data to the backup application;
wherein the backup application creates a backup file on the backup medium based upon the data provided to the backup application.

3. The method of claim 2 wherein determining the virtual size comprises determining a size of the contents of the stub file, wherein the virtual size is equal to the size of the contents of the stub file.

4. The method of claim 3 wherein providing data to the backup application comprises providing the contents of the stub file to the backup application.

5. The method of claim 2 wherein:
determining the virtual size comprises determining that the contents of the stub file comprise metadata, the metadata comprising information related to one or more attributes of the first file, wherein the virtual size is a size of the metadata; and
providing data to the backup application comprises providing the metadata to the backup application.

6. The method of claim 2 wherein:
determining the virtual size comprises determining that the contents of the stub file comprise metadata and a portion of data of the first file, wherein the virtual size is equal to the size of the metadata plus the size of the portion of data of the first file; and
providing data to the backup application comprises providing the metadata and the portion of data of the first file to the backup application.

7. The method of claim 1 wherein detecting that the backup application is backing-up the stub file comprises:
receiving information identifying a set of processes that perform backup operations; and
detecting when a file operation is performed by a process from the set of processes.

8. The method of claim 1 wherein detecting that the backup application is backing-up the stub file comprises:
receiving information identifying a set of users that perform backup operations; and
detecting when a file operation is performed by a user from the set of users.

9. A computer-implemented method of restoring a file, the method comprising:
detecting that a restore application has restored a file from a backup medium to a first storage location;
determining that the restored file is a stub file corresponding to a first file, wherein a portion of the first file has been migrated from the first storage location; and
setting a logical size of the restored stub file to a logical size of the first file prior to migration of the portion of the first file.

10. The method of claim 9 wherein setting the logical size of the restored stub file comprises determining the logical size of the first file prior to migration of the portion of the first file.

11. The method of claim 9 wherein the migrated portion of the first file is not recalled to the first storage location during the detecting, determining, and setting.

12. The method of claim 9 further comprising:
determining metadata associated with the first file; and
storing the metadata in the restored stub file.

13. The method of claim 9 wherein detecting that the restore application has restored the first file comprises:
receiving information identifying a set of processes that perform restore operations; and
detecting when a file operation is performed by a process from the set of processes.

14. The method of claim 9 wherein detecting that the restore application is about to restore the first file comprises:
receiving information identifying a set of users that perform restore operations; and
detecting when a file operation is performed by a user from the set of users.

15. A computer program product stored on a computer-readable medium for performing a file backup operation, the computer program product comprising:
code for detecting that a backup application is backing-up a stub file to a backup medium, wherein the stub file is stored in a first storage location in place of a first file due to migration of a portion of the first file from the first storage location; and
code for enabling backup of the stub file to the backup medium without recalling the migrated portion to the first storage location.

16. The computer program product of claim 15 wherein the code for enabling backup of the stub file comprises:
code for determining a virtual size based upon contents of the stub file;
code for providing the virtual size to the backup application; and
code for providing data to the backup application;
wherein the backup application creates a backup file on the backup medium based upon the data provided to the backup application.

17. The computer program product of claim 16 wherein the code for determining the virtual size comprises code for determining a size of the contents of the stub file, wherein the virtual size is equal to the size of the contents of the stub file.

18. The computer program product of claim 17 wherein the code for providing data to the backup application comprises code for providing the contents of the stub file to the backup application.

19. The computer program product of claim 15 wherein the code for detecting that the backup application is backing-up the stub file comprises:
code for receiving information identifying a set of processes that perform backup operations; and
code for detecting when a file operation is performed by a process from the set of processes.

20. The computer program product of claim 15 wherein the code for detecting that the backup application is backing-up the stub file comprises:
code for receiving information identifying a set of users that perform backup operations; and
code for detecting when a file operation is performed by a user from the set of users.

21. A computer program product stored on a computer-readable medium for restoring a file, the computer program product comprising:
code for detecting that a restore application has restored a file from a backup medium to a first storage location;
code for determining that the restored file is a stub file corresponding to a first file, wherein a portion of the first file has been migrated from the first storage location; and
code for setting a logical size of the restored stub file to a logical size of the first file prior to migration of the portion of the first file.

22. The computer program product of claim 21 wherein the migrated portion of the first file is not recalled to the first storage location during the detecting, determining, and setting.

23. The computer program product of claim 21 further comprising:
code for determining metadata associated with the first file; and
code for storing the metadata in the restored stub file.

24. The computer program product of claim 21 wherein the code for detecting that the restore application has restored the first file comprises:
code for receiving information identifying a set of processes that perform restore operations; and
code for detecting when a file operation is performed by a process from the set of processes.

25. The computer program product of claim 21 wherein the code for detecting that the restore application is about to restore the first file comprises:
code for receiving information identifying a set of users that perform restore operations; and
code for detecting when a file operation is performed by a user from the set of users.

26. An apparatus for performing a file backup operation, the apparatus comprising:
a first storage unit;
a second storage unit;
a backup medium; and
a data processing system;
wherein the first storage unit stores a stub file in place of a first file due to migration of a portion of the first file from the first storage unit to the second storage unit; and
wherein the data processing system is configured to:
detect that a backup application is backing-up the stub file to the backup medium; and
enable backup of the stub file to the backup medium without recalling the migrated portion from the second storage unit to the first storage unit.

27. The apparatus of claim 26 wherein the data processing system is configured to:
determine a virtual size based upon contents of the stub file;
provide the virtual size to the backup application; and
providing data to the backup application;
wherein the backup application creates a backup file on the backup medium based upon the data provided to the backup application.

28. An apparatus for performing restoring a file, the apparatus comprising:
a first storage unit;
a second storage unit;
a backup medium; and
a data processing system; and
wherein the data processing system is configured to:
detect that a restore application has restored a file from the backup medium to the first storage unit;
determine that the restored file is a stub file corresponding to a first file, wherein a portion of the first file has been migrated from the first storage unit to the second storage unit; and
set a logical size of the restored stub file to a logical size of the first file prior to migration of the portion of the first file.

29. The apparatus of claim 28 wherein the data processing system is configured to detect, determine, and set without recalling the migrated portion of the first file from the second storage unit to the first storage unit.

30. The apparatus of claim 28 wherein the data processing system is configured to:
determine metadata associated with the first file; and
store the metadata in the restored stub file.
